(19) United States
(12) Patent Application Publication
(10) Pub. No.: US 2009/0162027 A1
(43) Pub. Date: Jun. 25, 2009

(54) ELECTRONIC APPLIANCE

(75) Inventor: Takashi ICHINOSE, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/191,456

(22) Filed: Aug. 14, 2008

(30) Foreign Application Priority Data
Dec. 20, 2007 (JP) P2007-328505

(51) Int. Cl. H04N 5/91

(52) U.S. Cl. 386/83

(57) ABSTRACT

An electronic appliance for receiving and recording broadcasted images includes an input accepting unit configured to accept input of recording reservation information at least including a start time of recording and a channel corresponding to images to be recorded, an input determining unit configured to determine whether input of the channel is being accepted upon acceptance of the input of the start time, a time determining unit configured to determine, when it has been determined by the input determining unit that the input of the channel is being accepted, whether the start time is before the current time, and a record starting unit configured to start a recording process in the background on the basis of the channel accepted by the input accepting unit when the start time has been determined to be before the current time by the time determining unit.

### BACKGROUND OF THE INVENTION

1. Field of the Invention

The present invention relates to an electronic appliance capable of receiving and displaying a television broadcast and allowing an audience to view it and more particularly to an electronic appliance capable of recording by reservation the television broadcast received.

2. Description of the Related Art

Recently, with the increasing promotion of having multiple functions of electronic appliances such as mobile phones, a television displaying function of receiving and displaying images broadcasted by terrestrial digital broadcasting or the like to allow the audience to view it has come to be incorporated in mobile phones. In addition, there have been developed mobile phones having a function of recording a program in a main body memory or an external memory and a reservation recording function which is activated by a timer to automatically start recording of a program.

For example, in Japanese Unexamined Patent Application Publication No. 2007-129659, there is described a program reservation system designed to determine whether reservation is possible during setting of the reservation, thereby to realize appropriate reservation setting. This program reservation system is of the type that determines whether reservation can be accepted on the basis of a memory amount remaining in its memory unit, a time period required to record a program that has been reserved for recordings and the like and the reservation of this program is set in the case that the reservation is determined to be possible.

A conventional mobile phone is constructed such that in the case that reservation recording of a TV program which is currently being broadcasted or which is about to be broadcasted soon is manually set, the reservation is not allowed unless a time at which the recording is started comes after (in the future) the current time to some extent. Therefore, a problem occurs in that the reservation recording cannot be started promptly and hence scenes to be recorded are not recorded. In addition, the reservation of the recording cannot be accomplished unless both the start time and end time of recording are set, so that in the case that much time is taken to set the subscription, a problem occurs in that scenes to be recorded which are being broadcasted during the setting are not recorded.

On the other hand, it is also possible to adopt a method in which a user directly starts the recording by depressing one operation key for starting the recording and stops the recording by depressing another operation key for stopping the recording, instead of performing the reservation recording. However, in this case, the recording cannot be stopped unless the operation key for stopping the recording is depressed, which makes it necessary for the user to depress the operation key for stopping the recording at the end time of recording.

### SUMMARY OF THE INVENTION

The present invention has been conceived in view of the above mentioned problems intrinsic to the prior art. Accordingly, it is an object of the present invention to provide an electronic appliance making it possible to promptly start recording by a simple operation in the case that a TV program which is currently being broadcasted or is about to be broadcasted soon is to be recorded by reservation.

In order to solve the above mentioned problems, according to the present invention, there is provided an electronic appliance for receiving and recording broadcasted images, constituted by: an input accepting unit configured to accept input of recording reservation information at least including a start time of recording and a channel corresponding to the images to be recorded; an input determining unit configured to determine, when input of the start time has been accepted by the input accepting unit, whether input of the channel is being accepted by the input accepting unit; a time determining unit configured to determine, in the case that it has been determined by the input determining unit that the input of the channel is being accepted, whether the start time accepted by the input accepting unit is before the current time; and a recording starting unit configured to start, in the case that it has been determined by the time determining unit that the start time is before the current time, a recording process in the background on the basis of the channel accepted by the input accepting unit.

Owing to the electronic appliance according to the present invention, in the case that the TV program which is currently being broadcasted or is about to be broadcasted soon is to be recorded by reservation, it becomes possible to promptly start the recording by a simple operation of starting the recording in the background in advance at the moment that minimum requisite information is obtained for starting the reservation recording, even before reservation setting is completed.

### BRIEF DESCRIPTION OF THE DRAWINGS

FIG. 1 is a perspective view showing an electronic appliance (a mobile phone) according to the present invention;

FIG. 2 is a functional block diagram showing the electronic appliance (the mobile phone) according to the present invention;

FIG. 3 is a flowchart illustrating the procedures executed when the electronic appliance (the mobile phone) according to the present invention performs a reservation recording process;

FIG. 4A is a frame diagram showing a subscription input frame and FIG. 4B is a frame diagram showing a manual setting frame;

FIG. 5 is a flowchart illustrating the procedures executed when the electronic appliance (the mobile phone) according to the present invention performs a record starting process based on input of a start time of recording;

FIG. 6 is a frame diagram showing a recording instruction dialogue;

FIG. 7 is a flowchart illustrating the procedures executed when the electronic appliance (the mobile phone) according to the present invention performs a recording starting process on the basis of input of a channel corresponding to a program to be recorded; and

FIG. 8 is a flowchart illustrating the procedures executed when the electronic appliance (the mobile phone) according to the present invention performs a recording starting process on the basis of a timer for recording.

### DESCRIPTION OF THE PREFERRED EMBODIMENTS

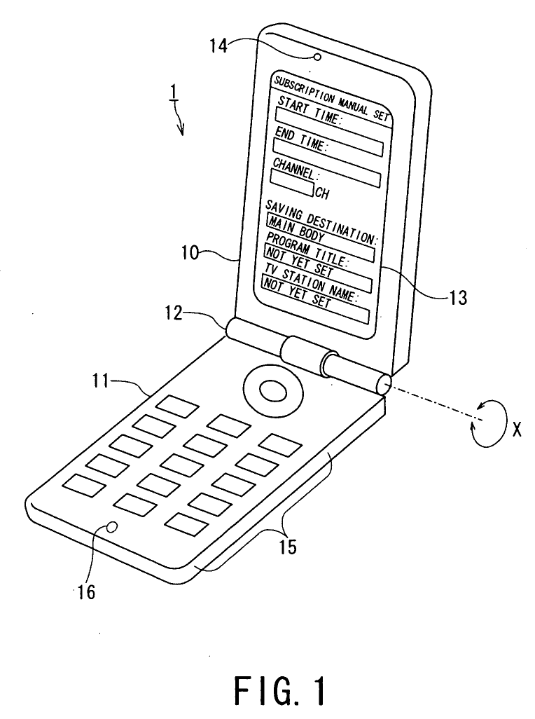

Next, preferred embodiments of the electronic appliance according to the present invention will be described with reference to the accompanying drawings. In the description, a clamshell-shaped mobile phone 1 constructed by connecting together a plurality of housings so as to be freely open/closed is given as an example of the electronic appliance according to the present invention. FIG. 1 is a perspective view showing a state in which the mobile phone 1 is open.

As shown in FIG. 1, the mobile phone 1 is mainly constituted of a rectangular plate-shaped upper housing 10 and a lower housing 11 which is almost the same as the upper housing 10 in shape. The upper housing 10 and the lower housing 11 contact each other when the mobile phone 1 is in a closed state so that their inner faces are covered. The upper housing 10 and the lower housing 11 are hinged together so as to nip a hinge portion 12 therebetween and the upper housing 10 is formed so as to be rotatable by a predetermined angle in a direction shown by an arrow X in FIG. 1, centering on the hinge portion 12 as a shaft. The mobile phone 1 can be changed from being in a closed state to an open state or from being in an open state to a closed state by rotating the upper housing 10 relative to the lower housing 11.

Within the upper housing 10 (on its surface on the side facing the lower housing 11), there are provided a liquid crystal display 13 for displaying a display frame including information such as letters/characters, images and others and a loudspeaker 14 for outputting a voice signal. In the closed state of the mobile phone 1, the liquid crystal display 13 and the loudspeaker 14 are covered with the lower housing 11 and hence are not exposed to the outside. When the upper housing 10 is rotated relative to the lower housing 11 to change the shape of the phone such that the phone is in the open state, the display 13 and the loudspeaker 14 are exposed to the outside.

Within the lower housing 11 (on its surface on the side facing the upper housing 10), there are provided operation keys 15 such as, for example, a direction key for moving a cursor and a display frame up and down and right and left, a selection key for selecting items, numeral keys for inputting numerals, a dial key for effecting a dialing process and others. On the lower housing 11, there is also provided a microphone 16 for receiving a voice signal. In the closed state of the mobile phone 1, the operation keys 15 and the microphone 16 are covered with the upper housing 10 and hence are not exposed to the outside. While, when the upper housing 10 is rotated relative to the lower housing 11 to change the shape of the phone to the open state, the operation keys 15 and the microphone 16 are exposed to the outside.

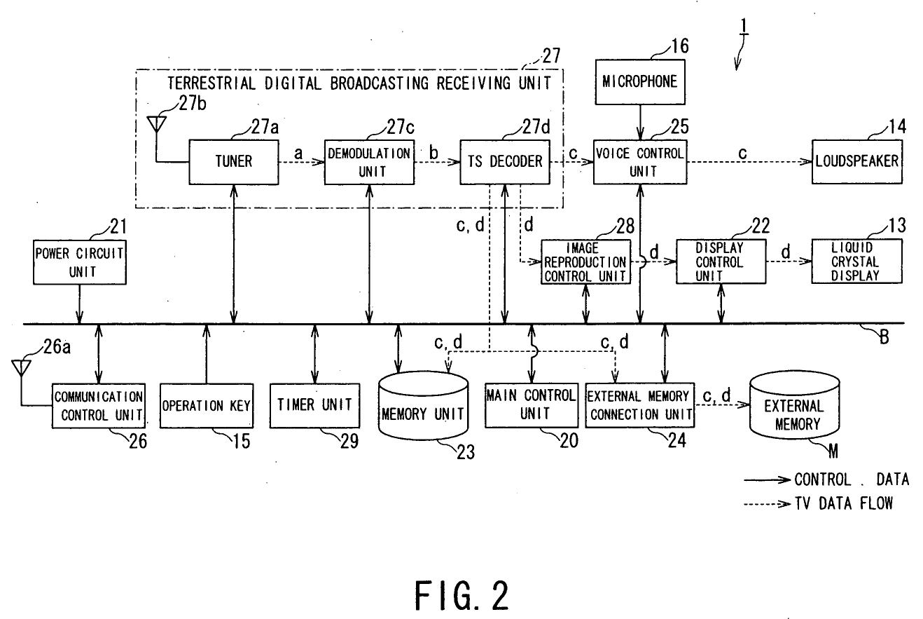

FIG. 2 is a functional block diagram of the mobile phone 1 according to the present invention. As shown in FIG. 2, the mobile phone 1 includes a main control unit 20, a power circuit unit 21, a display control unit 22, a memory unit 23, an external memory connection unit 24, a voice control unit 25, a communication control unit 26, a terrestrial digital broadcasting receiving unit 27, an image reproduction control unit 28 and a timer unit 29. These units are connected with one another so as to communicate with one another via a bus B.

The main control unit 20 includes a CPU (Central Processing Unit) for performing various data processing and operations so as to generally control the mobile phone 1 and to perform various operational processes and controlling processes. The main control unit 20 is provided with an input interface for the operation keys 15 so as to perform various processes on the basis of input by the operation keys 15. The main control unit 20 is also provided with a built-in clock for counting time by using, for example, an RTC (Real Time Clock) circuit and always determines the current time by using this clock circuit.

The power circuit unit 21 turns on/off the power source on the basis of input from the user by means of the operation keys 15 to supply the power to the respective units from a power supply source (a battery or the like) in the ON state of the power source, thereby making the mobile phone 1 functional. The display control unit 22 is provided with a display interface for the liquid crystal display 13 to display, on the liquid crystal display 13, display information such as documents, still images, dynamic images and others on the basis of the control performed by the main control unit 20.

The memory unit 23 includes memories such as a RAM (Random Access Memory) for temporarily storing data used when the main control unit 20 performs processes, a ROM (Read Only Memory) for storing processing programs performed by the main control unit 20, a hard disk, a nonvolatile memory and others. Processing programs used when the main control unit 20 performs a reservation recording process and a recording starting process described below are stored, for example, in the ROM.

The external memory connection unit 24 is provided with an input/output interface for external memories M such as, for example, an SD (Secure Digital) card (a registered trademark), a USB (Universal Serial Bus) memory and others so as to perform processes of writing and reading data into and out from the external memory M concerned when the external memory M has been electrically connected to the mobile phone 1.

The voice control unit 25 generates an analog voice signal from a voice signal picked up by the microphone 16 on the basis of the control by the main control unit 20 and converts this analog voice signal into a digital voice signal. In addition, when a digital voice signal is obtained, the voice control unit 25 converts this digital voice signal to an analog voice signal on the basis of the control by the main control unit 20 and outputs this signal from the loudspeaker 14 as a sound.

The communication control unit 26 performs a spectrum back-diffusing process on a signal received via an antenna 26a to restore data, on the basis of the control by the main control unit 20. The data thus restored is displayed on the liquid crystal display 13 or recorded in the memory unit 23 as instructed by the main control unit 20. In addition, on the basis of the control by the main control unit 20, the communication control unit 26 performs a spectrum diffusing process on the data input via the operation keys 15 or the data stored in the memory unit 23 and transmits the data thus processed via the antenna 26a.

The terrestrial digital broadcasting receiving unit 27 is provided with a tuner 27a, a demodulation portion 27c and a TS decoder 27d. The tuner 27a receives a modulated wave “a” of data broadcasted by terrestrial digital broadcasting (including terrestrial digital and one-segment broadcasting) from a broadcasting station (not shown) for terrestrial digital broadcasting via an antenna 27b. The demodulation portion 27c obtains and demodulates the modulated wave “a” received by the tuner 27a to generate encoded image information “b” for terrestrial digital broadcasting. The TS decoder 27b obtains and decodes the encoded image information “b” generated from the demodulation portion 27c and transmits voice information “c” in the encoded image information “b” to the voice control unit 25 and transmits dynamic image information “d” in the encoded image information “b” to the image reproduction control unit 28. The voice control unit 25 which has received the voice information “c” outputs this voice information “c” from the loudspeaker 14 as a sound. The image reproduction control unit 28 which has received the dynamic image information “d” displays the received dynamic image information “d” on the liquid crystal display 13 via the display control unit 22.

As instructed by the main control unit 20, the TS decoder 27d stores the terrestrial-digital-broadcasted voice information “c” and dynamic image information “d” in the memory unit 23 or the external memory M connected to the external memory connection unit 24. This is the image recording process.

The image reproduction control unit 28, when it obtains the terrestrial-digital-broadcasted image information “d” received by the terrestrial digital broadcasting receiving unit 27 and the dynamic image information “d” stored in the memory unit 23, displays the obtained dynamic image information “d” on the liquid crystal display 13 via the display control unit 22.

The timer unit 29 performs timer processing of notifying the user of the lapse of a predetermined time period, as instructed by the main control unit 20. The timer unit 29, when it receives a timer start instruction by the main control unit 20, starts counting of the predetermined time period (the time period set in the timer) on the basis of this timer start instruction and transmits a notice that the timer has come to the end of the predetermined time period to the main control unit 20 after the predetermined time period has been reached.

The mobile phone 1 has a recording function for recording a terrestrial-digital-broadcast TV program received by the terrestrial digital broadcasting receiving unit 27 and also has a reservation recording function for starting the recording of the TV program at a previously designated start time and completing the recording of the program at a previously designated end time.

The memory unit 23 stores therein recording reservation information required for recording a program by reservation. The recording reservation information is information which includes start time information indicative of a time at which the recording is to be started, end time information indicative of a time at which the recording is to be stopped, channel information indicative of a channel corresponding to the program to be recorded, saving destination information indicative of a saving destination in which the image information of the recorded TV program is saved, program title information indicative of the title of the recorded TV program, broadcasting TV station information indicative of a broadcasting TV station from which the recorded TV program has been broadcasted and other information so as to correspond to one another. In the saving destination information, for example, information regarding the “main body” (the memory unit 23), the “external memory” (the external memory M) and others is contained. In the mobile phone 1, the recording process is performed on the basis of the above mentioned recording reservation information.

In an existing general type mobile phone, a reservation input frame for inputting recording reservation information is displayed and the recording reservation information is input by a user on the basis of this reservation input frame, by which reservation recording is set. This mobile phone is of the type that no program can be reserved for recording unless the start time of recording comes after (in the future) the current time to some extent. Therefore, the reservation recording cannot be promptly started and hence there is a problem that scenes to be recorded cannot be recorded. In addition, since the reservation of the recording cannot be completed unless both the start time and end time of recording are set, there is also a problem that if much time is taken to set the reservation, scenes to be recorded which are being broadcasted during the reservation setting cannot be recorded.

On the other hand, it is also possible to adopt a method in which a user directly starts the recording by depressing the operation key 15 to start the recording and stops the recording by depressing the operation key 15 to stop the recording, instead of performing the reservation recording. However, in this case, the recording cannot be stopped unless the operation key 15 to stop the recording is depressed, which makes it necessary for the user to depress the operation key 15 to stop the recording at the end time of recording.

For these reasons, the mobile phone 1 is constructed such that upon the reservation recording, the recording is started promptly at the moment that the start time and the channel which are minimum requisite items for recording have been input and input of the end time of recording and others is accepted even after the recording has been started, which makes it possible to complete the setting of the reservation recording even after the recording has been started.

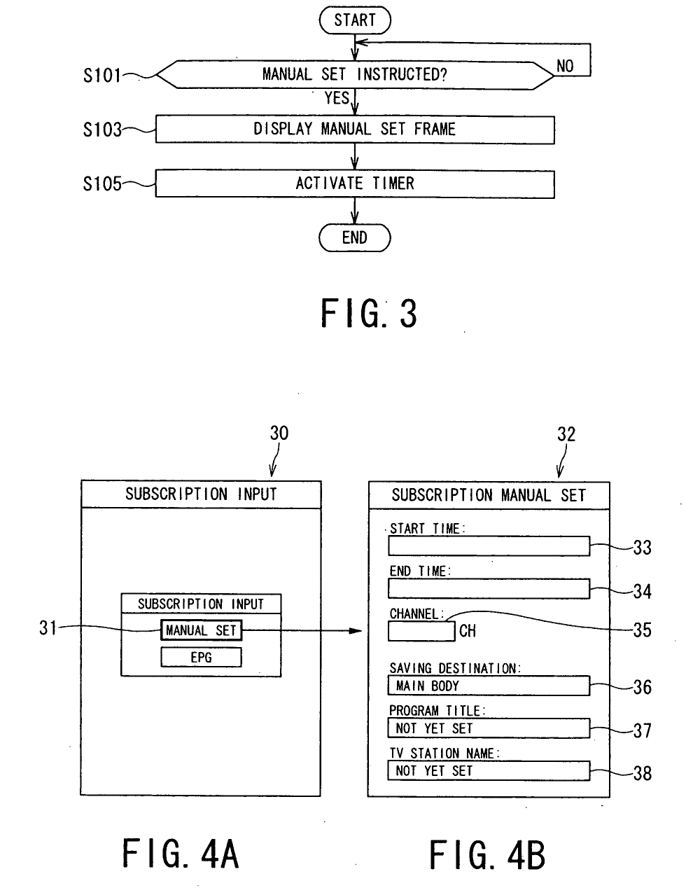

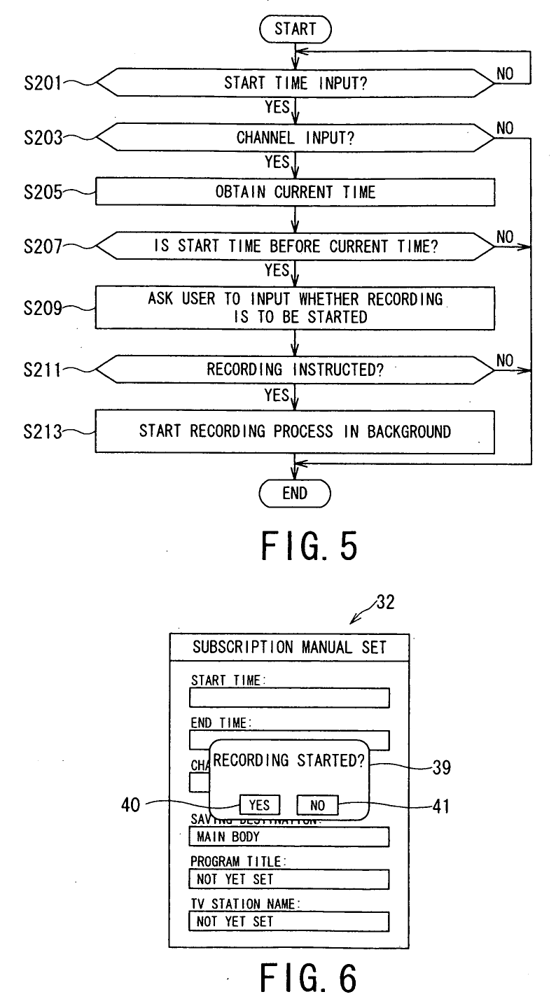

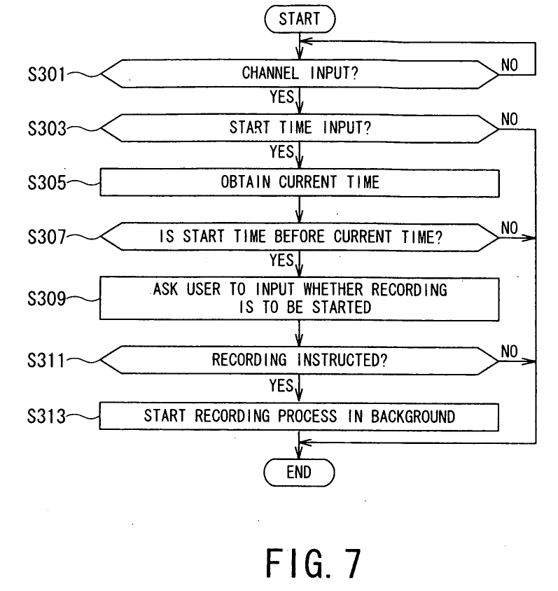

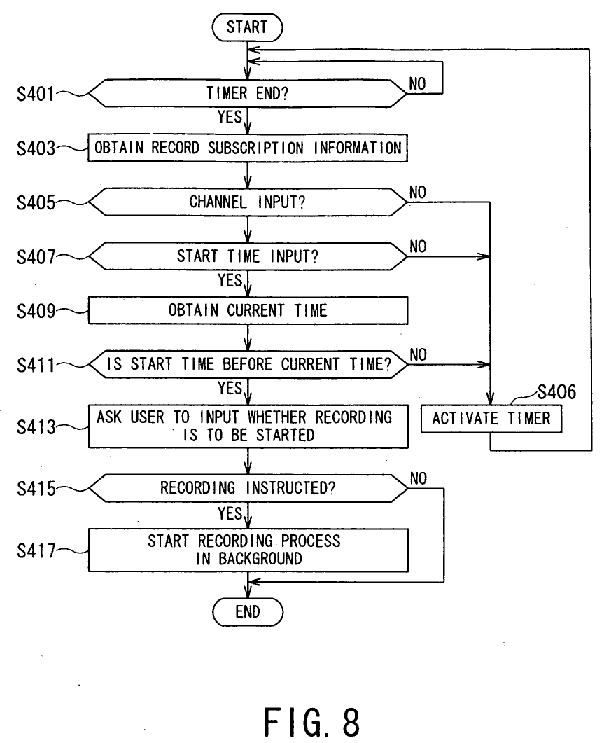

Next, procedures through which the mobile phone 1 performs the reservation recording process will be described using flowcharts shown in FIGS. 3, 5, 7 and 8. Incidentally, FIG. 5 is a flowchart illustrating the recording starting process performed on the basis of the input of the start time of recording, FIG. 7 is a flowchart illustrating the recording starting process performed on the basis of the input of the channel corresponding to the program to be recorded and FIG. 8 is a flowchart illustrating the recording starting process performed on the basis of the timer. Note that, in the following description, the term “step” may be omitted, for example, “step S101” may be written as “S101”.

First, the main control unit 20 displays, on the liquid crystal display 13, a reservation input frame 30 used when the user inputs reservation for recording. As shown in FIG. 4A, the reservation input frame 30 is provided with a manual set button 31 for manually setting the reservation recording. In manual setting of the reservation recording, the user instructs the mobile phone 1 to manually set the reservation recording by selecting the manual set button 31 using the operation key 15.

Then, as shown in FIG. 3, the main control unit 20 determines whether the manual setting of the reservation recording has been instructed (S101). In the case that the manual setting is not instructed (No at S101), the main control unit 20 waits as is. While, in the case that the manual setting has been instructed (Yes at S101), the main control unit 20 displays a manual setting frame 32 for manually inputting the recording reservation information by using the operation key 15 (S103). As shown in FIG. 4B, the manual setting frame 32 has a start time input field 33 for inputting the start time of recording, an end time input field 34 for inputting the end time of recording, a channel input field 35 for inputting the channel corresponding to the program to be recorded, a saving destination input field 36 for inputting the saving destination of the program to be recorded, a program title input field 37 for inputting the title of the program to be recorded, and a broadcasting TV station input field 38 for inputting the name of the broadcasting TV station corresponding to the program to be recorded.

The main control unit 20 transmits a timer start instruction to the timer unit 29 to activate the timer for which a predetermined time period has been previously set (S105). In this case, the predetermined time period refers to a periodic time interval set for determining whether the reservation recording is to be started, for example, every three seconds.

When the start time has been input, the main control unit 20 performs the recording starting process on the basis of the input of the start time of recording. As shown in FIG. 5, the main control unit 20 determines whether the start time of recording has been input (S201). On this occasion, in the case that information indicative of the time is input into the start time input field 33 of the manual setting frame 32, it is determined that the start time has been input. While, in the case that the start time of recording is not input (No at S201), the main control unit 20 waits until the start time of recording is input.

In the case that the start time of recording has been input (Yes at S201), the main control unit 20 determines whether the channel corresponding to the program to be recorded has been input (S203). On this occasion, in the case that information indicative of the channel has been input into the channel input field 35 of the manual setting frame 32, it is determined that the channel corresponding to the program to be recorded has been input. While, in the case that the channel corresponding to the program to be recorded has not been input (No at S203), the channel is not known and hence the recording process cannot be performed, so that the recording starting process on the basis of the input of the start time of recording is terminated, without starting the recording process.

In the case that the channel corresponding to the program to be recorded is input (Yes at S203), the main control unit 20 obtains the current time (S205). Then, the main control unit 20 determines whether the start time of recording input at the step S201 is before the current time obtained at the step S205 (5207). For example, in the case that the start time of recording is “Jan. 1, 2008; 18:00” and the current time is “Jan. 1, 2008; 19:00”, it is determined that the start time of recording is before the current time. In the case that it has been determined that the start time of recording is not before the current time (No at S207), the start time of recording has not yet been reached, so that the recording starting process on the basis of the input of the start time of recording is terminated, without starting the recording process.

While, in the case that the start time of recording has been determined to be before the current time (Yes at S207), the main control unit 20 displays a recording instruction dialogue 39 for inputting whether the recording process is to be started or takes other measures to ask the user to input whether the recording process is to be started (S209). As shown in FIG. 6, the recording instruction dialogue 39 is provided with a “YES” button 40 for instructing to start the recording process and a “NO” button 41 for instructing not to start the recording process.

Then, the main control unit 20 determines whether the recording process has been instructed (5211). On this occasion, in the case that the “YES” button 40 of the recording instruction dialogue 39 has been selected, it is determined that the recording process has been instructed. While, in the case that the “NO” button 41 has been selected, it is determined that the recording process has not been instructed. In the case that the recording process has not been instructed (No at S211), the main control unit 20 terminates the recording starting process on the basis of the input of the start time of recording, without starting the recording process.

While, in the case that the recording process has been instructed (Yes at S211), the main control unit 20 starts the recording process in the background (S213). That is, the main control unit 20 starts the recording process on the basis of the start time input at the step S201 and the channel input at the step S203 in a state that the manual set frame displayed on the liquid crystal display 13 at the step S103 is still being displayed. On this occasion, the user can continue inputting the recording reservation information on the basis of the manual setting frame 32.

Alternatively, when the channel has been input, the main control unit 20 performs the recording starting process on the basis of the input of the channel corresponding to the program to be recorded. As shown in FIG. 7, the main control unit 20 determines whether the channel corresponding to the program to be recorded has been input (S301). On this occasion, in the case that information indicative of the channel is input into the channel input field 35 of the manual setting frame 32, it is determined that the channel corresponding to the program to be recorded has been input. While, in case that the channel corresponding to the program to be recorded is not input (No at S301), the main control unit 20 waits until the channel corresponding to the program to be recorded is input.

When the channel corresponding to the program to be recorded has been input (Yes at S301), the main control unit 20 determines whether the start time of recording is input (S303). On this occasion, in the case that information indicative of the time is input into the start time input field 33 of the manual set frame 32, it is determined that the start time of recording is input. While, in the case that the start time of recording is not input (No at S303), the start time is not known and hence the recording process cannot be performed, so that the recording starting process performed on the basis of the input of the channel corresponding to the program to be recorded is terminated, without starting the recording process.

While, in the case that the start time of recording is input (Yes at S303), the main control unit 20 obtains the current time (S305). Then, the main control unit 20 determines whether the start time of recording input at the step S303 is before the current time obtained at the step S305 (S307), as in the case at the step S207. When it has been determined that the start time of recording is not before the current time (No at S307), the start time of recording has not yet been reached, so that the recording starting process performed on the basis of the input of the channel corresponding to the program to be recorded is terminated, without starting the recording process.

While, in the case that the start time of recording has been determined to be before the current time (Yes at S307), as shown in FIG. 6, the main control unit 20 displays the recording instruction dialogue 39 for inputting whether the recording process is to be started or takes other measures to ask the user to input whether the recording process is to be started (S309).

Then, the main control unit 20 determines whether the recording process has been instructed (S311). On this occasion, in the case that the “YES” button 40 of the record instruction dialogue 39 has been selected, it is determined that the recording process has been instructed. While, in the case that the “NO” button 41 has been selected, it is determined that the recording process has not been instructed. In the case that the recording process has not been instructed (No at S311), the main control unit 20 terminates the recording starting process performed on the basis of the input of the channel corresponding to the program to be recorded, without starting the recording process.

When the recording process has been instructed (Yes at S311), the main control unit 20 starts the recording process in the background (S313) as in the case at the step S213. That is, the main control unit 20 starts the recording process on the basis of the start time input at the step S303 and the channel input at the step S301, in a state that the manual set frame which has been displayed on the liquid crystal display 13 at the step S103 is still being displayed. On this occasion, the user can continue inputting the recording reservation information by using the manual setting frame 32.

Next, the main control unit 20 performs the recording starting process on the basis of the timer activated at the step S105. This process is performed in the case that the start time of recording has been determined to be after the current time at the moment that, for example, the start time information and the channel information have been input.

As shown in FIG. 8, first, the main control unit 20 determines whether the timer activated at the step S105 (or at a step S406 described below) has reached the end of the predetermined period (S401). On this occasion, the main control unit 20 determines that the timer has reached the end of the predetermined period on the basis of reception of a timer end notice from the timer unit 29. When the timer has not yet reached the end of the predetermined period (No at S401), the main control unit 20 waits until the timer reaches the end of the predetermined period.

In the case that the timer has reached the end of the predetermined period (Yes at S401), the main control unit 20 obtains the recording reservation information input into the manual settings frame 32 displayed on the liquid crystal display 13 or the recording reservation information already stored in the memory unit 23 (S403).

Then, the main control unit 20 determines whether the channel corresponding to the program to be recorded has been input on the basis of the recording reservation information obtained at the step S403 (S405). On this occasion, in the case that the recording reservation information input into the manual set frame 32 has been obtained at the step S403, when the information indicative of the channel is input into the channel input field 35 of the manual settings frame 32, it is determined that the channel corresponding to the program to be recorded has been input. Or, in the case that the recording reservation information has been obtained from the memory unit 23 at the step S403, when the recording reservation information includes the channel information, it is determined that the channel corresponding to the program to be recorded has been input.

In the case that the channel corresponding to the program to be recorded is not input (No at S405), the main control unit 20 activates the timer again (S406). That is, the main control unit 20 transmits the timer start instruction to the timer unit 29 to activate the timer for which the predetermined time period (for example, every three seconds) is set as in the case at the step S105. Then, since the channel is not known and hence the recording process cannot be performed, the main control unit 20 waits until the timer reaches the end of the predetermined period without starting the recording process, returning to the step S401.

In the case that the channel corresponding to the program to be recorded has been input (Yes at S405), the main control unit 20 determines whether the start time of recording is input (S407). On this occasion, in the case that the recording reservation information input into the manual set frame 32 has been obtained at the step S403, when the information indicative of the time is input into the start time input field 33 of the manual settings frame 32, it is determined that the start time of recording has been input. Or, in the case that the recording reservation information has been obtained from the memory unit 23 at the step S403, when the recording reservation information includes the start time information, it is determined that the start time of recording has been input.

In the case that the start time of recording is not input (No at S407), the main control unit 20 activates the timer again (S406). That is, the main control unit 20 transmits the timer start instruction to the timer unit 29 to activate the timer for which the predetermined time period (for example, every three seconds) is set as in the case at the step S105. Then, since the start time is not known and hence the recording process cannot be performed, the main control unit 20 waits until the timer reaches the end of the predetermined period without starting the recording process, returning to the step S401.

In the case that the start time of recording is input (Yes at S407), the main control unit 20 obtains the current time (S409). Then, the main control unit 20 determines whether the start time of recording input at the step S407 is before the current time obtained at the step S409 as in the case at the step S207 (S411). In the case that it has been determined that the start time of recording is not before the current time (No at S411), the main control unit 20 activates the timer again (S406). That is, the start time of recording has not yet been reached, so that the main control unit 20 waits until the timer reaches the end of the predetermined period without starting the recording process, returning to the step S401.

In the case that the start time of recording has been determined to be before the current time (Yes at S411), the main control unit 20 displays the record instruction dialogue 39 for inputting whether the recording process is to be started on the liquid crystal display 13 as shown in FIG. 6 or takes other measures to ask the user to input whether the recording process is to be started (S413).

Then, the main control unit 20 determines whether the recording process has been instructed (S415). On this occasion, in the case that the “YES” button 40 on the record instruction dialogue 39 has been selected, it is determined that the recording process has been instructed. While, in the case that the “NO” button 41 has been selected, it is determined that the recording process has not been instructed. In the case that the recording process has not been instructed (No at S415), the main control unit 20 terminates the record starting process.

Alternatively, in the case that the recording process has not been instructed at the step S415, the time period set in the timer may be set longer (for example, every one minute) and then the timer start instruction may be transmitted to the timer unit 29, thereby to activate the timer. On this occasion, the main control unit 20 waits until the timer reaches the end of the predetermined period, returning to the step S401.

In the case that the recording process has been instructed (Yes at S415), the main control unit 20 starts the recording process in the background (S417) as in the case at the step S213. That is, in the case that the recording reservation information input into the manual setting frame 32 has been obtained at the step S403, the main control unit 20 starts the recording process on the basis of the start time input at the step S407 and the channel input at the step S405, in a state that the manual setting frame 32 displayed on the liquid crystal display 13 is still being displayed.

Also alternatively, the recording process in the background may be started with no execution of the process of asking the user to instruct whether the recording process is to be started at the steps S209 and 5211, the steps S309 and S311 and the steps S413 and S415.

In the above mentioned manner, the mobile phone 1 determines whether the channel information has already been input upon inputting the recording start time information by manual setting and, when the channel information has already been input, compares the start time of recording with the current time. Then, when the start time of recording is before the current time, the mobile phone 1 starts the recording process. On this occasion, the mobile phone 1 performs the recording process in the background and the manual setting frame 32 is left displayed on the display plane of the liquid crystal display 13. As a result, the user can input other information such as the end time of recording and the like after the recording process has been started.

Likewise, upon inputting the channel information by the manual setting, the mobile phone 1 determines whether the recording start time information has already been input, and when the start time information has already been input, compares the start time of recording with the current time. Then, when the start time of recording is before the current time, the mobile phone 1 starts this recording process. On this occasion, the mobile phone 1 performs the recording process in the background and the manual setting frame 32 is left displayed on the liquid crystal display 13. As a result, the user can input other information such as the end time of recording and the like once the recording process has been started.

Further, in the case that the start time of recording is in the future with respect to the current time, upon inputting the recording start time information and the channel information, the start time of recording is compared with the current time at constant intervals using the periodic timer. When the start time of recording is a time prior to the current time, the mobile phone 1 starts this recording process. As in the above cases, the mobile phone 1 performs the recording process in the background and, when the manual set frame 32 is displayed on the liquid crystal display 13, the display of this manual set frame 32 is maintained.

As described above, according to the electronic appliance (the mobile phone 1) of the present invention, in the case that the reservation recording process is performed with respect to a TV program which is currently being broadcasted or which is about to be broadcasted soon, the recording process is started in the background, in advance, at the moment that the minimum requisite information (the start time information and the channel information) has been input for starting the reservation recording, even before the reservation setting is completed, by which it becomes possible to promptly start the recording process by a simple operation.

Also, according to the electronic appliance (the mobile phone 1) of the present invention, the input of the recording reservation information such as the end time of recording and the like can be accepted even after the recording process has been started, by which it becomes possible for the user to promptly start the recording process even when the reservation recording is set after the start time of recording has been reached and it becomes also possible for the user to stop the recording process using the reservation recording function at a desired time, with no need to manually stop the recording process at the desired time.

Although the present invention has been described with respect to the mobile phone 1, the present invention is not limited to the above, but any information processing terminals may be employed as long as these are information processing terminals of the type capable of performing the reservation recording process such as PHSs (Personal Handyphone Systems), PDAs (Personal Digital Assistants), portable television sets, portable game machines, portable music players, and PCs (Personal Computers).

What is claimed is:

1. An electronic appliance for receiving and recording broadcasted images comprising:
an input accepting unit configured to accept input of recording reservation information at least including a start time of recording and a channel corresponding to images to be recorded;
an input determining unit configured to determine, when input of the start time has been accepted by the input accepting unit, whether input of the channel is being accepted by the input accepting unit;
a time determining unit configured to determine, in the case that it has been determined by the input determining unit that the input of the channel is being accepted, whether the start time accepted by the input accepting unit is before the current time; and
a recording starting unit configured to start, in the case that it has been determined by the time determining unit that the start time is before the current time, a recording process in the background on the basis of the channel accepted by the input accepting unit.

2. The appliance according to claim 1, further comprising:
a notifying unit configured to activate a periodic timer for which a predetermined time period is set in the case that the input accepting unit has started acceptance of the input and for providing notification of the end of the predetermined time period,
wherein the input determining unit determines, in the case that it has been determined by the time determining unit that the start time is not before the current time, whether the input of the channel has been accepted by the input accepting unit every time the end of the predetermined time period is notified by the notifying unit.

3. An electronic appliance for receiving and recording broadcasted images comprising:
an input accepting unit configured to accept input of recording reservation information at least including a start time of recording and a channel corresponding to images to be recorded;
an input determining unit configured to determining, when input of the channel has been accepted by the input accepting unit, whether input of the start time is being accepted by the input accepting unit;
a time determining unit configured to determine, in the case that it has been determined by the input determining unit that the input of the start time is being accepted, whether the start time accepted by the input accepting unit is before the current time; and
a recording starting unit configured to start, in the case that it has been determined by the time determining unit that the start time is before the current time, a recording process in the background on the basis of the channel accepted by the input accepting unit.

4. The appliance according to claim 3, further comprising:
a notifying unit configured to activate a periodic timer for which a predetermined time period is set in the case that the input accepting unit has started acceptance of the input and for providing notification of the end of the predetermined time period,
wherein the input determining unit determines, in the case that it has been determined by the time determining unit that the start time is not before the current time, whether the input of the start time has been accepted by the input accepting unit every time the end of the predetermined time period is notified by the notifying unit.

5. An electronic appliance for receiving and recording broadcasted images comprising:
an input accepting unit configured to accept input of recording reservation information at least including a start time of recording and a channel corresponding to images to be recorded;
a notifying unit configured to activate a periodic timer for which a predetermined time period is set in the case that the input accepting unit has started acceptance of the input and for providing notification of the end of the predetermined time period;
an input determining unit configured to determine, every time notification of the end of the predetermined time period is provided from the notifying unit, whether input of both the start time and the channel has been accepted by the input accepting unit;
a time determining unit configured to determine, in the case that it has been determined by the input determining unit that the input of both the start time and the channel has been accepted, whether the start time accepted by the input accepting unit is before the current time; and
a recording starting unit configured to start, in the case that it has been determined by the time determining unit that the start time is before the current time, a recording process in the background on the basis of the channel accepted by the input accepting unit.
